(19) United States
(12) Patent Application Publication
(10) Pub. No.: US 2025/0192977 A1
(43) Pub. Date: Jun. 12, 2025

(54) Syntonization through Physical Layer of Interconnects

(71) Applicant: MELLANOX TECHNOLOGIES, LTD., Yokneam (IL)

(72) Inventors: Dotan David Levi, Kiryat Motzkin (IL); Wojciech Wasko, Mlynek (PL); Natan Manevich, Ramat HaSharon (IL)

(21) Appl. No.: 19/060,838

(22) Filed: Feb. 24, 2025

Related U.S. Application Data
(63) Continuation of application No. 17/868,841, filed on Jul. 20, 2022, now Pat. No. 12,289,388.

(51) Int. Cl. H04L 7/027; H04L 12/40

(52) U.S. Cl. CPC H04L 7/027; H04L 12/40

(57) ABSTRACT

In one embodiment, a clock syntonization system includes a first compute node including a first physical hardware clock to operate at a first clock frequency, a second compute node, and an interconnect data bus to transfer data from the first compute node at a data rate indicative of the first clock frequency of the first physical hardware clock, and wherein the second compute node includes clock synchronization circuitry to derive a second clock frequency from the data rate of the transferred data, and provide a clock signal at the derived second clock frequency.

### RELATED APPLICATION INFORMATION

The present application is a Continuation Application of U.S. patent application Ser. No. 17/868,841 of Levi, et al., filed 20 Jul. 2022, the disclosure of which is hereby incorporated herein by reference.

### FIELD OF THE INVENTION

The present invention relates to computer systems, and in particular, but not exclusively to, syntonization of computer devices.

### BACKGROUND

Clock synchronization among network devices is used in many network applications. One application of using a synchronized clock value is for measuring one-way latency from one device to another device. If the clocks are not synchronized the resulting one-way latency measurement will be inaccurate.

Synchronization is typically achieved by syntonization, in which the clock frequency of two devices is aligned, and aligning offset and phase between the two devices.

For Ethernet, there are two complementary methods to achieve synchronization. One is Synchronous Ethernet (SyncE), which is a physical-layer protocol which achieves syntonization based on the receive/transmit symbol rate. SyncE is an International Telecommunication Union Telecommunication (ITU-T) Standardization Sector standard for computer networking that facilitates the transference of clock signals over the Ethernet physical layer. In particular, SyncE enables clock syntonization inside a network with respect to a master clock.

The other is Precision Time Protocol (PTP), which is a packet-based protocol that may be used with SyncE to align offset (e.g., in Coordinated Universal Time (UTC) format) and phase between two clocks. It should be noted that PTP may be used alone over Ethernet (without SyncE), but this is typically used for lower accuracy use cases. PTP is used to synchronize clocks throughout a computer network, and is considered to be the de-facto standard for this purpose.

Time, clock and frequency synchronization is crucial in some modern computer network applications. It enables 5G and 6G networks, and is proven to enhance the performance of data center workloads.

### SUMMARY

There is provided in accordance with an embodiment of the present disclosure, a clock syntonization system, including a first compute node including a first physical hardware clock to operate at a first clock frequency, a second compute node, and an interconnect data bus to transfer data from the first compute node at a data rate indicative of the first clock frequency of the first physical hardware clock, and wherein the second compute node includes clock synchronization circuitry to derive a second clock frequency from the data rate of the transferred data, and provide a clock signal at the derived second clock frequency.

Further in accordance with an embodiment of the present disclosure the first compute and second compute node may include any one or more of the following a central processing unit, a graphics processing unit, a network interface controller, a switch, a bridge, and a data processing unit.

Still further in accordance with an embodiment of the present disclosure the interconnect data bus is a peripheral device interconnect data bus.

Additionally in accordance with an embodiment of the present disclosure the data is transferred over the interconnect data bus in at least one digital signal.

Moreover, in accordance with an embodiment of the present disclosure the second compute node includes a second physical hardware clock to operate at a third clock frequency, the clock synchronization circuitry being configured to discipline the second physical hardware clock responsively to a difference between the derived second clock frequency and the third clock frequency.

Further in accordance with an embodiment of the present disclosure the second compute node includes a second physical hardware clock, the clock synchronization circuitry being configured to discipline the second physical hardware clock responsively to a difference between the derived second clock frequency and a transmission rate at which data is transferred from the second compute node to the first compute node via the interconnect data bus.

Still further in accordance with an embodiment of the present disclosure the second compute node includes a second physical hardware clock, the clock synchronization circuitry being configured to discipline the second physical hardware clock of the second compute node responsively to a difference between the data rate at which the data is received from the first compute node by the second compute node, and a transmission rate at which data is transferred from the second compute node to the first compute node via the interconnect data bus.

Additionally in accordance with an embodiment of the present disclosure the data rate is modulated to spread interference across a range of frequencies so that a variation of the data rate over time describes a modulated signal of frequency against time.

Moreover, in accordance with an embodiment of the present disclosure the clock synchronization circuitry includes filtering circuitry to remove modulation from the modulated signal, the clock synchronization circuitry being configured to derive the second clock frequency from the modulated signal with the modulation removed.

Further in accordance with an embodiment of the present disclosure the clock synchronization circuitry includes filtering circuitry to digitally remove modulation from the modulated signal, the clock synchronization circuitry being configured to derive the second clock frequency from the modulated signal with the modulation removed.

Still further in accordance with an embodiment of the present disclosure the clock synchronization circuitry includes filtering circuitry to transform the modulated signal yielding a Fourier Transform, and identify the second clock frequency from the Fourier Transform.

Additionally in accordance with an embodiment of the present disclosure the clock synchronization circuitry is configured to sample the frequency of the modulated signal yielding multiple frequency values, average the frequency values yielding an average value, and derive the second clock frequency from the average value.

Moreover, in accordance with an embodiment of the present disclosure the clock synchronization circuitry is configured to derive the second clock frequency by fitting parameters of a mathematic model of the modulated signal, the parameters including a frequency based on the first clock frequency.

Further in accordance with an embodiment of the present disclosure the clock synchronization circuitry is configured to fit the parameters based on performing a regression analysis of the mathematical model.

Still further in accordance with an embodiment of the present disclosure the clock synchronization circuitry is configured to fit the parameters responsively to using a machine learning model.

There is also provided in accordance with still another embodiment of the present disclosure a clock syntonization method, including transferring data from a first compute node to a second compute node at a data rate indicative of a first clock frequency of a first physical hardware clock of the first compute node, deriving a second clock frequency from the data rate of the transferred data, and providing a clock signal at the derived second clock frequency in the second compute node.

Additionally in accordance with an embodiment of the present disclosure the data is transferred over an interconnect data bus in at least one digital signal.

Moreover, in accordance with an embodiment of the present disclosure, the method includes disciplining a second physical hardware clock of the second compute node operating at a third clock frequency responsively to a difference between the derived second clock frequency and the third clock frequency.

Further in accordance with an embodiment of the present disclosure, the method includes disciplining a second physical hardware clock of the second compute node responsively to a difference between the derived second clock frequency and a transmission rate at which data is transferred from the second compute node to the first compute node via an interconnect data bus.

Still further in accordance with an embodiment of the present disclosure, the method includes disciplining a second physical hardware clock of the second compute node responsively to a difference between the data rate at which the data is received from the first compute node by the second compute node, and a transmission rate at which data is transferred from the second compute node to the first compute node via an interconnect data bus.

Additionally in accordance with an embodiment of the present disclosure, the method includes modulating the data rate to spread interference across a range of frequencies so that a variation of the data rate over time describes a modulated signal of frequency against time.

Moreover, in accordance with an embodiment of the present disclosure the clock synchronization circuitry includes filtering circuitry to remove modulation from the modulated signal, the clock synchronization circuitry being configured to derive the second clock frequency from the modulated signal with the modulation removed.

Further in accordance with an embodiment of the present disclosure, the method includes digitally removing modulation from the modulated signal and deriving the second clock frequency from the modulated signal with the modulation removed.

Still further in accordance with an embodiment of the present disclosure, the method includes transforming the modulated signal yielding a Fourier Transform, and identifying the second clock frequency from the Fourier Transform.

Additionally in accordance with an embodiment of the present disclosure, the method includes sampling the frequency of the modulated signal yielding multiple frequency values, averaging the frequency values yielding an average value, and deriving the second clock frequency from the average value.

Moreover, in accordance with an embodiment of the present disclosure, the method includes deriving the second clock frequency by fitting parameters of a mathematic model of the modulated signal, the parameters including a frequency based on the first clock frequency.

Further in accordance with an embodiment of the present disclosure, the method includes fitting the parameters based on performing a regression analysis of the mathematical model.

Still further in accordance with an embodiment of the present disclosure, the method includes fitting the parameters responsively to using a machine learning model.

### BRIEF DESCRIPTION OF THE DRAWINGS

The present invention will be understood from the following detailed description, taken in conjunction with the drawings in which:

FIG. 1 is a block diagram view of a clock syntonization system constructed and operative in accordance with an embodiment of the present invention;

FIG. 2 is a flowchart including steps in a method of operation of the system of FIG. 1;

FIG. 3 is a flowchart including steps in a first method to derive a clock frequency from a spread-spectrum signal;

FIG. 4 is a flowchart including steps in a second method to derive a clock frequency from a spread-spectrum signal;

FIG. 5 is a flowchart including steps in a third method to derive a clock frequency from a spread-spectrum signal; and

FIG. 6 is a flowchart including steps in a fourth method to derive a clock frequency from a spread-spectrum signal.

### DESCRIPTION OF EXAMPLE EMBODIMENTS

### Overview

SyncE and PTP provide clock synchronization between network devices. There is also a need to push timing awareness towards the software stack enabling applications running on different compute nodes to be synchronized. For example, there may be one or more graphics processing unit (GPU) and/or central processing unit (CPU) processes that need to be synchronized. The synchronized timing speeds up utilization and balance of the work between the compute nodes, making connectivity much more efficient with less queues etc.

For many high-speed interconnects (e.g., Peripheral Component Interconnect Express (PCIe) or NVLink), packet-based protocols may provide synchronization between the devices involved (e.g., Precision Time Measurement (PTM) for PCIe). However, these packet-based protocols lack physical-layer-based syntonization and may stall performance. Other solutions such as using semaphore also lack performance.

Embodiments of the present invention address some of the above drawbacks by providing physical-layer-based syntonization between compute nodes (e.g., between two CPUs or GPUs) over an interconnect data bus wherein frequency information is transferred between compute nodes over the interconnect data bus based on the data rate (e.g., symbol rate) of the data transferred in digital signals between the compute nodes. In other words, the data transmission rate from one compute node (first compute node) to another (second compute node) is based on the clock frequency of the transmitting compute node. The receiving compute node then uses the frequency information indicated by the data transmission rate to generate or adjust its clock so that the clock of the receiving compute node is syntonized with the transmitting compute node. The interconnect data bus may include any suitable interconnect data bus such as PCIe, Ethernet, and InfiniBand.

In some embodiments, the second compute node may derive the clock frequency of the first compute node from the data rate of the data being transferred by the interconnect data bus between the first compute node and the second compute node. The derived frequency may then be used by the second compute node to generate a clock signal for use in the second compute node or to correct a clock signal generated by a clock of the second compute node so that the clock signal being used to drive timing in the second compute node is syntonized with the clock frequency of the first compute node.

In some embodiments, the second compute node adjusts its clock signal based on a difference between the derived frequency and the current frequency of the clock of the second compute node. In some embodiments, the second compute node adjusts its clock signal based on a difference between the transmission (TX) data rate from the second compute node to the first compute node and the receive (RX) data rate by the second compute node from the first compute node. In some embodiments, the second compute node adjusts its clock signal based on a difference between: the derived frequency; and the transmission (TX) data rate from the second compute node to the first compute node.

In many highspeed interconnects the frequency of data transmission may be non-constant and changes (e.g., is modulated) over some range. This is done to spread interference across a range of frequencies so that interference with other signals is reduced at any specific frequency. In PCIe, the signals may be reduced up to 0.5% of the base frequency of the clock of the transmitting compute node. Specifications may also specify how the frequency should be modulated (i.e., at what rate). In PCIe it is between 30 and 33 KHz.

The above is known as spread spectrum and modulates the base frequency of the clock used to drive the transmission data rate in a spread spectrum signal. In some embodiments, the base frequency of the clock is derived from the spread spectrum signal. One method to derive the base frequency of the clock is to use a high pass filter or band pass filter so that the spread spectrum modulation is removed to reveal the base frequency of the clock. Another method digitally separates the base frequency of the clock from the modulation signal, for example, using a Fourier Transform (FT). In yet another method, the spread spectrum signal may be sampled at suitably wide intervals to reveal an average signal indicative of the base frequency of the clock. In some embodiments, finite or infinite response filters may be used to transform the spread spectrum signal (e.g., using a FT) to identify the base frequency of the clock.

In some embodiments, a mathematical model of the spread spectrum signal is found, and parameters of the mathematical model are fit using regression analysis or a trained machine learning model to identify the base frequency of the clock which is one of the parameters. The parameters may also include amplitude of spread spectrum signal, modulating frequency of the spread spectrum signal, and phase offset of the function modulating the base frequency (e.g., the 30-33 kHz wave). For example, for a given time T0 of a local clock, T1 is the closest time to T0 when the modulating function reaches some specific value (e.g., the minimum, maximum, or mean of the modulating function) considered to be the beginning of the modulating function's cycle. T0 less T1 is the phase offset of the modulating function. By way of a more explicit, non-limiting example, where the modulating function is a sine function, the equation for the modulating function may be expressed as F(t)=Asin(Bt+C), where A is amplitude, B is related to frequency, and C is the phase offset.

### System Description

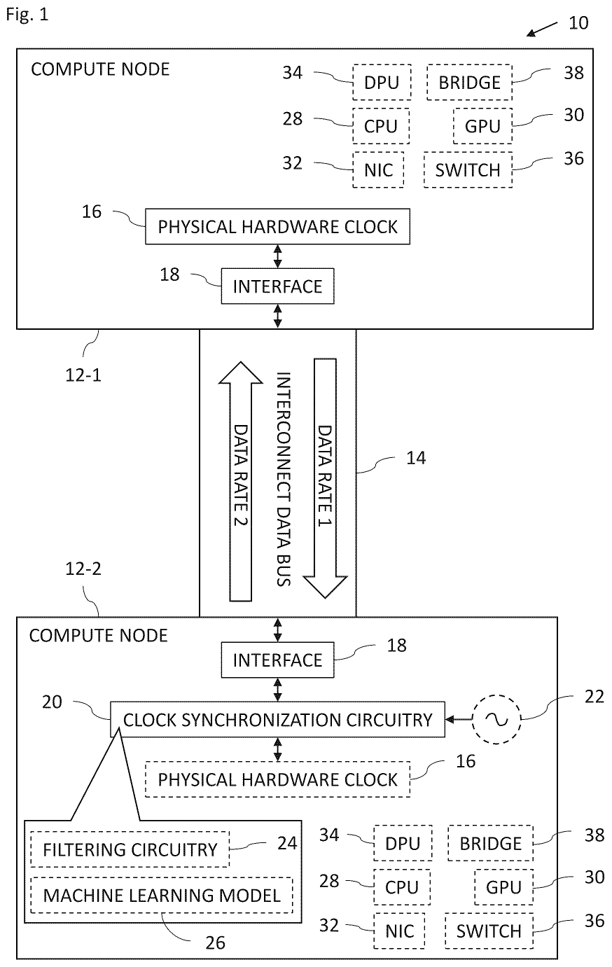

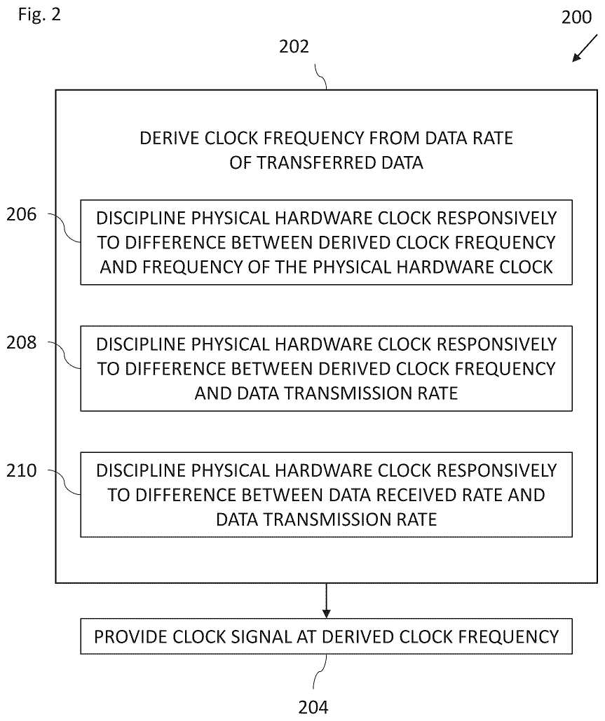

Reference is now made to FIG. 1, which is a block diagram view of a clock syntonization system 10 constructed and operative in accordance with an embodiment of the present invention. Reference is also made to FIG. 2, which is a flowchart 200 including steps in a method of operation of the system 10 of FIG. 1.

The system 10 includes a plurality of compute nodes 12 (only two shown for the sake of simplicity) connected via one or more interconnect data buses 14 (only one shown for the sake of simplicity). The interconnect data bus 14 may include a peripheral device interconnect data bus. The interconnect data bus 14 may operate according to any suitable protocol, e.g., PCIe, Ethernet, or InfiniBand.

The system 10 is configured to synchronize all the compute nodes 12 in the system 10 to the clock frequency of one of the compute nodes 12 designated as a synchronization leader. The synchronization leader uses its frequency source to drive a transmission symbol rate on the interconnect data buses 14 from one compute node 12 to the other. The compute nodes 12 not designated as the synchronization leader are designated as synchronization followers. Each synchronization follower may use the symbol rate of data received on the interconnect data bus 14 to synchronize its clock to the clock rate indicated by the symbol rate of the received data or use the symbol rate to directly drive a clock signal, described in more detail below.

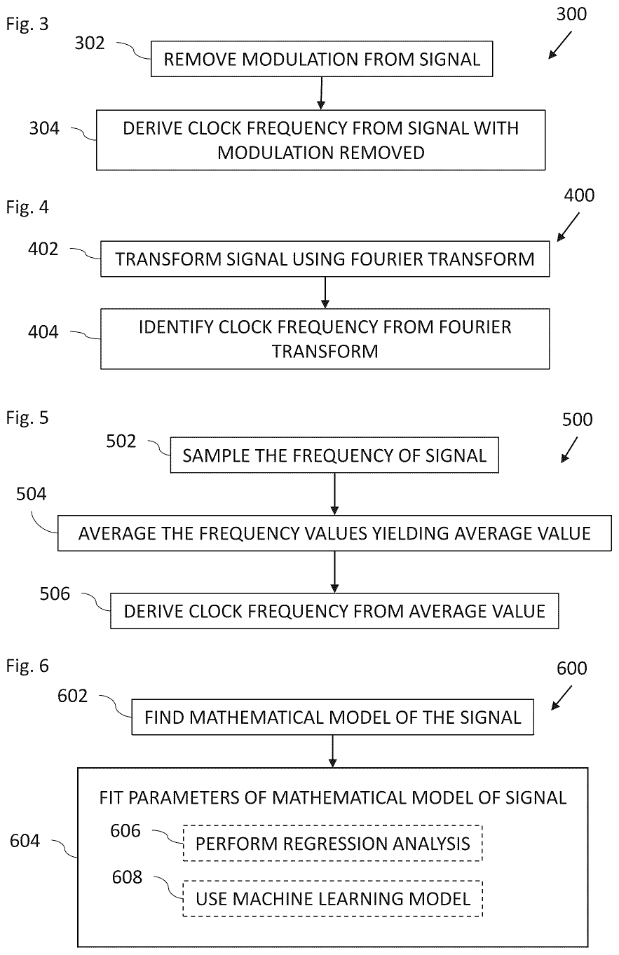

Each compute node 12 may include a physical hardware clock 16 and an interface 18. The physical hardware clock 16 is configured to maintain a clock frequency and/or clock time. The interface 18 is configured to transfer data with one or more of the compute nodes 12 over the interconnect data bus 14. Each compute node 12 may include clock synchronization circuitry 20 configured to synchronize the compute node 12 (in which the clock synchronization circuitry 20 is disposed) to the clock frequency of another compute node 12. Each compute 12 may include an oscillator 22 to provide a clock signal for use when no external clock input is provided. The clock synchronization circuitry 20 may include filtering circuitry 24 and/or a machine learning model 26, described in more detail below with reference to FIGS. 3 and 6. Each compute node 12 may include computing circuitry which may include one or more of the following: a CPU 28; a GPU 30; a network interface controller (NIC) 32; a data processing unit (DPU) 34, which may include a NIC and other processors such as multiple core processors; a switch 36; and/or a bridge 38.

In FIG. 1, the physical hardware clock 16 of compute node 12-1 is configured to operate at a first clock frequency. In FIG. 1, the interconnect data bus 14 is configured to transfer data from compute node 12-1 at a first data rate (e.g., data rate 1) indicative of the first clock frequency of the physical hardware clock 16 of compute node 12-1.

The clock synchronization circuitry 20 of compute node 12-2 is configured to: derive a second clock frequency from the data rate of the transferred data (e.g., data rate 1) from compute node 12-1 (block 202); and provide a clock signal at the derived second clock frequency (block 204). In some embodiments, the clock signal provided in compute node 12-2 may be generated directly from the data rate of the transmitted data (e.g., data rate 1) and used in the compute node 12-2 for timing issues such as generating timestamps, timing execution of software, and setting a second data rate (e.g., data rate 2) at which data is transmitted by the interconnect data bus 14 from compute node 12-2 to compute node 12-1.

In some embodiments, the interconnect data bus 14 is configured to transmit data in a digital signal from compute node 12-2 to compute node 12-1 (or another one of the compute nodes 12) at the second data rate (e.g., data rate 2), which may be based on the clock frequency of the physical hardware clock 16 of compute node 12-2 (and operate at a third clock frequency), which may be driven by the oscillator 22 of compute node 12-2. The clock synchronization circuitry 20 of compute node 12-2 is configured to: derive the second clock frequency from the data rate of the transferred data (e.g., data rate 1) from compute node 12-1 (block 202); and provide the clock signal at the derived second clock frequency (block 204) by adjusting a clock signal provided by the physical hardware clock 16 of compute node 12-2 to the second clock frequency. In other words, if the physical hardware clock 16 of compute node 12-1 is running faster than the physical hardware clock 16 of compute node 12-2 as evidenced by the difference between the second and third clock frequency, or between data rate 1 and data rate 2, or between the second clock frequency and data rate 2, or between data rate 1 and the third clock frequency, then the clock synchronization circuitry 20 instructs the physical hardware clock 16 to speed up, and vice-versa. The adjustment of the physical hardware clock 16 of compute node 12-2 may be affected using a feedback loop which iteratively adjusts the clock frequency of the physical hardware clock 16 of compute node 12-2.

In some embodiments, the clock synchronization circuitry 20 of the compute node 12-2 is configured to discipline the physical hardware clock 16 of the compute node 12-2 responsively to a difference between the derived second clock frequency and the third clock frequency (block 206).

In some embodiments, the clock synchronization circuitry 20 of the compute node 12-2 is configured to discipline the physical hardware clock 16 of the compute node 12-2 responsively to a difference between the derived second clock frequency and a transmission rate (e.g., data rate 2) at which data is transferred from the compute node 12-2 to the compute node 12-1 via the interconnect data bus 14 (block 208).

In some embodiments, the clock synchronization circuitry 20 of the compute node 12-2 is configured to discipline the physical hardware clock 16 of the compute node 12-2 responsively to a difference between: the data rate (e.g., data rate 1) at which the data is received from the compute node 12-1 by the compute node 12-2; and a transmission rate (e.g., data rate 2) at which data is transferred from the compute node 12-2 to the compute node 12-1 via the interconnect data bus 14 (block 210).

The clock synchronization circuitry 20 may include any suitable frequency synthesizer such as a frequency jitter synchronizer and/or jitter network synchronizer clock. An example of a suitable frequency synthesizer 14 is Ultra-Low Jitter Network Synchronizer Clock LMK05318 commercially available from Texas Instruments Inc., 12500 TI Boulevard Dallas, Texas 75243 USA. The frequency synthesizer may receive a control signal (to adjust the clock frequency up or down) or a clock signal as input (e.g., when the compute node 12-2 does not include a physical hardware clock but uses the clock signal recovered from the data rate of data received over interconnect data bus 14) and output a clock signal responsively to the input control signal or clock signal. When no control signal or clock signal is input, the frequency synthesizer may generate a clock signal based on the output of the oscillator 22. In some embodiments, the frequency synthesizer may be replaced with a signal selector or switch which selectively uses the output of the oscillator 22 or the frequency of the received data (RX) signal as input.

In some embodiments, the synchronization leader may measure the difference between its own symbol transmission rate and the rate of symbols it receives from one or more of the synchronization followers (or perform a clock recovery of the received data stream and compare the recovered clock to the clock of the synchronization leader) to assess the syntonization accuracy of the follower(s) and take appropriate action, such as raise an alarm, log an event, and/or report a status to software.

In practice, some or all of the functions of the clock synchronization circuitry 20 may be combined in a single physical component or, alternatively, implemented using multiple physical components. These physical components may comprise hard-wired or programmable devices, or a combination of the two. In some embodiments, at least some of the functions of the clock synchronization circuitry 20 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

Reference is now made to FIG. 3, which is a flowchart 300 including steps in a first method to derive a clock frequency from a spread-spectrum signal. Many modern systems employ a feature called “spread spectrum clocking”. Spread spectrum clocking (SSC) aims to dissipate emitted electromagnetic noise over a range of frequencies, thus reducing the interference on any one frequency, an effect known as spectral amplitude reduction. SSC is implemented by modulating the “reference” or “base” high-frequency signal with a lower-frequency wave. Typically, the characteristics of the modulated signal (or at least their permitted values) are governed by specifications. For example, in case of PCIe, the frequency of the modulating signal has to be between 30 and 33 kHz and the clock frequency can be down-spread by (depending on the system) −0.5/−0.3% of the reference frequency. The specifications of the different high-speed interconnects may or may not dictate the form/shape of the modulating SSC wave. In some examples, the modulating wave was a triangular wave.

In some embodiments, the data rate (of data transfer from the compute node 12-1 to compute node 12-2) is modulated to spread interference across a range of frequencies so that a variation of the data rate over time describes a modulated signal of frequency against time. The filtering circuitry 24 of clock synchronization circuitry 20 is configured to remove modulation from the modulated signal (block 302). The clock synchronization circuitry 20 is configured to derive the second clock frequency from the modulated signal with the modulation removed (block 304).

In some embodiments, the filtering circuitry 24 may include a high-pass or band-pass filter which is configured to remove the modulation from the modulated signal. In other embodiments, the filtering circuitry 24 is configured to digitally remove modulation from the modulated signal, and the clock synchronization circuitry 20 is configured to derive the second clock frequency from the modulated signal with the modulation removed. For example, a Fourier Transform (FT) of the modulated signal is performed, the modulation frequency is removed from the FT, an inverse FT is then performed of the FT with the modulation frequency removed, and then the second clock frequency is found from the inverse FT.

Reference is now made to FIG. 4, which is a flowchart 400 including steps in a second method to derive a clock frequency from a spread-spectrum signal. The filtering circuitry 24 is configured to transform the modulated signal yielding a Fourier Transform (block 402); and identify the second clock frequency from the Fourier Transform (block 404), e.g., by finding the peak in the FT which is not the modulation frequency.

Reference is now made to FIG. 5, which is a flowchart 500 including steps in a third method to derive a clock frequency from a spread-spectrum signal. The clock synchronization circuitry 20 is configured to: sample the frequency of the modulated signal (yielding multiple frequency values), e.g., spaced at wide enough intervals to achieve an average sampling (block 502); average the frequency values yielding an average value (block 504); and derive the second clock frequency from the average value (block 506).

Reference is now made to FIG. 6, which is a flowchart 600 including steps in a fourth method to derive a clock frequency from a spread-spectrum signal. The method includes finding a mathematical model of the modulated signal (block 602). The model includes parameters such as the base frequency (based on the first clock frequency), amplitude of spread spectrum signal, modulating frequency of the spread spectrum signal, and phase offset. The clock synchronization circuitry 20 is configured to derive the second clock frequency by fitting the parameters of the mathematic model of the modulated signal (block 604).

In some embodiments, clock synchronization circuitry 20 is configured to fit the parameters based on performing a regression analysis of the mathematical model (block 606). In other embodiments, the clock synchronization circuitry 20 is configured to fit the parameters responsively to using a machine learning model (block 608). The machine learning module may be generated, for example, by training a decision tree or neural network with inputs equal to the modulated signal and outputs equal to the parameters. The trained decision tree or neural network is used with modulated signal as input to yield an output comprising the parameters which include the base frequency.

Various features of the invention which are, for clarity, described in the contexts of separate embodiments may also be provided in combination in a single embodiment. Conversely, various features of the invention which are, for brevity, described in the context of a single embodiment may also be provided separately or in any suitable sub-combination.

The embodiments described above are cited by way of example, and the present invention is not limited by what has been particularly shown and described hereinabove. Rather the scope of the invention includes both combinations and sub-combinations of the various features described hereinabove, as well as variations and modifications thereof which would occur to persons skilled in the art upon reading the foregoing description and which are not disclosed in the prior art.

What is claimed is:

1. A second compute node, comprising:
an interconnect data bus interface to receive data transferred via an interconnect data bus from a first compute node at a data rate indicative of a first clock frequency of a first physical hardware clock of the first compute node; and
clock synchronization circuitry to:
derive a second clock frequency from the data rate of the transferred data; and
provide a clock signal at the derived second clock frequency.

2. The second compute node according to claim 1, further comprising any one or more of the following: a central processing unit; a graphics processing unit; a network interface controller; a switch; a bridge; and a data processing unit.

3. The second compute node according to claim 1, wherein the interconnect data bus is a peripheral device interconnect data bus.

4. The second compute node according to claim 1, wherein the data is transferred over the interconnect data bus in at least one digital signal.

5. The second compute node according to claim 1, further comprising a second physical hardware clock to operate at a third clock frequency, the clock synchronization circuitry being configured to discipline the second physical hardware clock responsively to a difference between the derived second clock frequency and the third clock frequency.

6. The second compute node according to claim 1, further comprising a second physical hardware clock, the clock synchronization circuitry being configured to discipline the second physical hardware clock responsively to a difference between the derived second clock frequency and a transmission rate at which data is transferred from the second compute node to the first compute node via the interconnect data bus.

7. The second compute node according to claim 1, further comprising a second physical hardware clock, the clock synchronization circuitry being configured to discipline the second physical hardware clock of the second compute node responsively to a difference between: the data rate at which the data is received from the first compute node by the second compute node; and a transmission rate at which data is transferred from the second compute node to the first compute node via the interconnect data bus.

8. The second compute node according to claim 1, wherein the data rate is modulated to spread interference across a range of frequencies so that a variation of the data rate over time describes a modulated signal of frequency against time.

9. The second compute node according to claim 8, wherein the clock synchronization circuitry includes filtering circuitry to remove modulation from the modulated signal, the clock synchronization circuitry being to derive the second clock frequency from the modulated signal with the modulation removed.

10. The second compute node according to claim 8, wherein the clock synchronization circuitry includes filtering circuitry to digitally remove modulation from the modulated signal, the clock synchronization circuitry being to derive the second clock frequency from the modulated signal with the modulation removed.

11. The second compute node according to claim 8, wherein the clock synchronization circuitry includes filtering circuitry to:
transform the modulated signal yielding a Fourier Transform; and
identify the second clock frequency from the Fourier Transform.

12. The second compute node according to claim 8, wherein the clock synchronization circuitry is configured to: sample the frequency of the modulated signal yielding multiple frequency values; average the frequency values yielding an average value; and derive the second clock frequency from the average value.

13. The second compute node according to claim 8, wherein the clock synchronization circuitry is configured to derive the second clock frequency by fitting parameters of a mathematic model of the modulated signal, the parameters including a frequency based on the first clock frequency.

14. The second compute node according to claim 13, wherein the clock synchronization circuitry is configured to fit the parameters based on performing a regression analysis of the mathematical model.

15. The second compute node according to claim 13, wherein the clock synchronization circuitry is configured to fit the parameters responsively to using a machine learning model.

16. A clock syntonization method, comprising:
receiving data transferred via an interconnect data bus from a first compute node by a second compute node at a data rate indicative of a first clock frequency of a first physical hardware clock of the first compute node;
deriving, by the second compute node, a second clock frequency from the data rate of the transferred data; and
providing, by the second compute node, a clock signal at the derived second clock frequency in the second compute node.

17. The method according to claim 16, wherein the data is transferred over an interconnect data bus in at least one digital signal.

18. The method according to claim 16, further comprising disciplining a second physical hardware clock of the second compute node operating at a third clock frequency responsively to a difference between the derived second clock frequency and the third clock frequency.

19. The method according to claim 16, further comprising disciplining a second physical hardware clock of the second compute node responsively to a difference between the derived second clock frequency and a transmission rate at which data is transferred from the second compute node to the first compute node via an interconnect data bus.

20. The method according to claim 16, further comprising disciplining a second physical hardware clock of the second compute node responsively to a difference between: the data rate at which the data is received from the first compute node by the second compute node; and a transmission rate at which data is transferred from the second compute node to the first compute node via an interconnect data bus.

21. The method according to claim 16, further comprising modulating the data rate to spread interference across a range of frequencies so that a variation of the data rate over time describes a modulated signal of frequency against time.
